(19) United States
(12) Patent Application Publication
(10) Pub. No.: US 2011/0261018 A1
(43) Pub. Date: Oct. 27, 2011

(54) OPTICAL TOUCH DEVICE AND LIGHT SENSING MODULE THEREOF

(75) Inventors: HUI-HSUAN CHEN, Hsinchu (TW); Chiang-Yuan Chuang, Hsinchu (TW)

(73) Assignee: PixArt Imaging Inc., Hsinchu (TW)

(21) Appl. No.: 12/947,280

(22) Filed: Nov. 16, 2010

(30) Foreign Application Priority Data
Apr. 21, 2010 (TW) 099112532
Jul. 14, 2010 (TW) 099123162

(51) Int. Cl. G06F 3/042

(52) U.S. Cl. 345/175

(57) ABSTRACT

An optical touch device having a touch area is provided. The optical touch device includes at least a light sensing module disposed beside the touch area. The light sensing module includes a sensing unit and at least a reflecting member. The sensing unit has a plurality of sensing regions. Each of the sensing regions has a field of view. The at least a reflecting member is disposed in the front of at least one of the sensing regions so as to turn the field of view of the corresponding sensing region. The optical touch device is adapted to be applied to an electronic product. Moreover, two light sensing modules are also provided.

### FIELD OF THE INVENTION

The present invention relates to a touch device, and more particularly to an optical touch device and a light sensing module thereof.

### BACKGROUND OF THE INVENTION

A touch device has an advantage of easy operation. Recently, the touch device has been widely applied to various electronic products, for example, mobile telephones, personal digital assistants (PDAs), digital cameras, music players, computers, satellite navigation devices, touch screens, and so on. Generally, a familiar type of the touch device is, for example, a resistive touch device, a capacitive touch device or an optical touch device. The optical touch device has a lower cost comparative to the resistive touch device or the capacitive touch device.

FIG. 1 is a schematic view of a conventional optical touch device applied to a touch display device. Referring to FIG. 1, the conventional optical touch device includes two sensing chips 50. The two sensing chips 50 are respectively disposed at two corners of a display panel 60 and at two ends of a side 62 of the display panel 60. Each of the two sensing chips 50 has a sensing surface 52. An included angle θ between a normal vector 53 of the sensing surface 52 and the side 62 of the display panel 60 is 45 degrees. In addition, each of the two sensing chips 50 has a field of view 54. The two fields of view 54 of the two sensing chips 50 are partially overlapped and cover a touch surface 64 of the display panel 60 entirely so as to sense a location of a touch member (e.g., a finger, a pen, etc.) on the touch surface 64.

Nowadays, the electronic products including the touch display devices have a developing trend of miniaturization. To miniaturize the electronic product, it is very critical to dispose various components of the electronic product in a limited space in a better manner. However, because the two sensing chips 50 of the conventional optical touch device are disposed at two corners of the display panel 60, the angles of disposing the sensing chips 50 are limited. In other words, the components of the conventional touch display device can not be disposed flexibly. Thus, the volume of the conventional touch display device can not be reduced effectively.

### SUMMARY OF THE INVENTION

The present invention provides an optical touch device, and the location and the angle of disposing the optical touch device are flexible.

The present invention also provides a light sensing module, and a sensing unit of the light sensing module includes two sensing regions so that the location and the angle of disposing the light sensing module are flexible.

The present invention further provides a light sensing module, and a sensing unit of the light sensing module includes three sensing regions so that the location and the angle of disposing the light sensing module are flexible.

To achieve at least of one the above-mentioned advantages, the present invention provides an optical touch device having a touch area. The optical touch device includes at least a light sensing module disposed beside the touch area. The light sensing module includes a sensing unit and at least a reflecting member. The sensing unit has a plurality of sensing regions. Each of the sensing regions has a field of view. The at least a reflecting member is disposed in the front of at least one of the sensing regions so as to turn the field of view of the corresponding sensing region.

In one embodiment provided by the present invention, the touch area is rectangular and has a first side, a second side, a third side and a fourth side. The first side faces to the third side, and the second side faces to the fourth side.

In one embodiment provided by the present invention, the at least a light sensing module includes a first light sensing module disposed beside the first side and a second light sensing module disposed beside the first side. The first light sensing module is near to the second side, and the second light sensing module is near to the fourth side. The sensing unit of each of the first light sensing module and the second light sensing module includes a first sensing region facing to the touch area and a second sensing region facing to the touch area. The reflecting member of the first light sensing module is disposed in the front of the first sensing region of the first light sensing module and is configured for turning the field of view of the first sensing region of the first light sensing module towards the fourth side. The reflecting member of the second light sensing module is disposed in the front of the first sensing region of the second light sensing module and is configured for turning the field of view of the first sensing region of the second light sensing module towards the second side.

In one embodiment provided by the present invention, the first sensing region of the first light sensing module is nearer to the second side than the second sensing region of the first light sensing module, and the first sensing region of the second light sensing module is nearer to the fourth side than the second sensing region of the second light sensing module.

In one embodiment provided by the present invention, the light sensing module includes a first light sensing module disposed beside the first side and a second light sensing module disposed beside the third side. The first light sensing module faces to the second light sensing module. The sensing unit of each of the first light sensing module and the second light sensing module includes a first sensing region facing to the touch area, a second sensing region facing to the touch area and a third sensing region facing to the touch area. Each of the first light sensing module and the second light sensing module includes two the reflecting members, one of the reflecting members is disposed in the front of the first sensing region and is configured for turning the field of view of the first sensing region towards the fourth side, and the other of the reflecting members is disposed in the front of the third sensing region and is configured for turning the field of view of the third sensing region towards the second side.

In one embodiment provided by the present invention, the second sensing region is located between the first sensing region and the third sensing region, and the first sensing region is nearer to the second side than the second sensing region.

In one embodiment provided by the present invention, each light sensing module further includes a plurality of lenses disposed in the front of the sensing regions respectively.

In one embodiment provided by the present invention, each reflecting member is a prism. The prism has a light incidence surface, a reflecting surface and a light emitting surface. The light emitting surface faces to the corresponding sensing region and is connected between the reflecting surface and the light incidence surface. The light incidence surface is a convex curved surface.

In one embodiment provided by the present invention, each sensing unit further includes a plurality of sensing chips, and each of the sensing chips includes one of the sensing regions of each sensing unit.

In one embodiment provided by the present invention, each sensing unit further includes a sensing chip having a substrate, and the sensing regions of each sensing unit are disposed on the substrate.

In one embodiment provided by the present invention, the fields of view of two adjacent sensing regions of each sensing unit are partially overlapped.

In one embodiment provided by the present invention, the optical touch device further includes at least an infrared light source module.

To achieve at least of one the above-mentioned advantages, the present invention also provides a light sensing module of an optical touch device. The light sensing module includes a sensing unit and a reflecting member. The sensing unit has a first sensing region and a second sensing region. Each of the first sensing region and the second sensing region has a field of view. The reflecting member is disposed in the front of the first sensing region so as to turn the field of view of the first sensing region.

In one embodiment provided by the present invention, the sensing unit includes a substrate, and the first sensing region and the second sensing region are disposed on the substrate. The sensing unit and the reflecting member are received in a package together.

In one embodiment provided by the present invention, the light sensing module further includes a plurality of lenses disposed in the front of the first and second sensing regions respectively.

In one embodiment provided by the present invention, the reflecting member is a prism. The prism includes a light incidence surface, a reflecting surface and a light emitting surface. The light emitting surface faces to the corresponding sensing region and is connected between the reflecting surface and the light incidence surface. The light incidence surface is a convex curved surface.

In one embodiment provided by the present invention, the fields of view of the first sensing region and the second sensing region are partially overlapped.

To achieve at least of one the above-mentioned advantages, the present invention further provides a light sensing module of an optical touch device. The light sensing module includes a sensing unit, a first reflecting member and a second reflecting member. The sensing unit has a first sensing region, a second sensing region and a third sensing region. Each of the first sensing region, the second sensing region and the third sensing region has a field of view. The first reflecting member is disposed in the front of the first sensing region so as to turn the field of view of the first sensing region. The second reflecting member is disposed in the front of the third sensing region so as to turn the field of view of the third sensing region.

In one embodiment provided by the present invention, the sensing unit includes a substrate, and the first sensing region, the second sensing region and the third sensing region are disposed on the substrate. The sensing unit, the first reflecting member and the second reflecting member are received in a package together.

In one embodiment provided by the present invention, the light sensing module further includes a plurality of lenses disposed in the front of the first sensing region, the second sensing region and the third sensing region respectively.

In one embodiment provided by the present invention, each of the first reflecting member and the second reflecting member is a prism. The prism includes a light incidence surface, a reflecting surface and a light emitting surface. The light incidence surface is connected between the reflecting surface and the light emitting surface. The light incidence surface is a convex curved surface. The light emitting surface of the first reflecting member faces to the first sensing region, and the light emitting surface of the second reflecting member faces to the third sensing region.

In one embodiment provided by the present invention, the fields of view of the first sensing region and the second sensing region are partially overlapped, and the fields of view of the first sensing region and the third sensing region are partially overlapped.

In the optical touch device of one embodiment of the present invention, the light sensing module includes at least a reflecting member disposed in the front of at least one of the sensing regions so as to turn the field of view of the corresponding sensing region. Thus, the location and the angle of disposing the light sensing module are flexible. Additionally, in the optical touch device of another two embodiments of the present invention, the light sensing module includes a plurality of sensing regions. A reflecting member is disposed in the front of at least one of sensing regions so as to turn the field of view of the corresponding sensing region. Thus, the location and the angle of disposing the light sensing module are flexible.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of a conventional optical touch device applied to a touch display device.

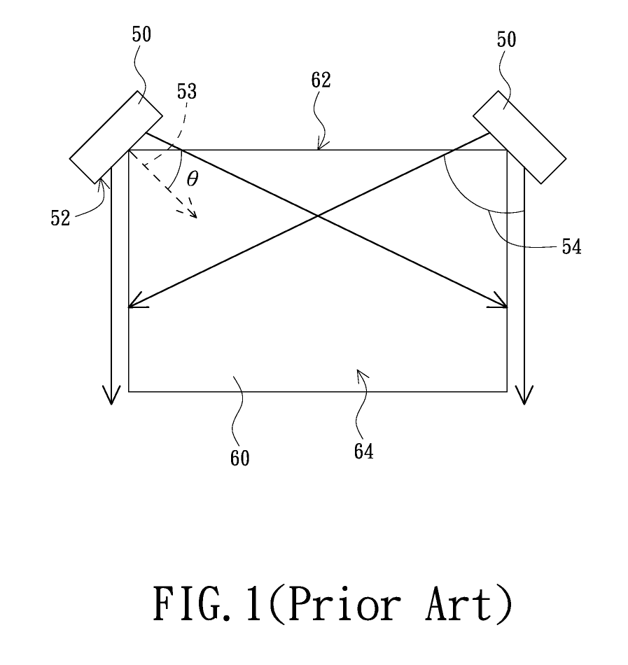

FIG. 2 is a schematic view of an optical touch device in accordance with an embodiment of the present invention.

FIG. 3 is a schematic view of an optical touch device in accordance with another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

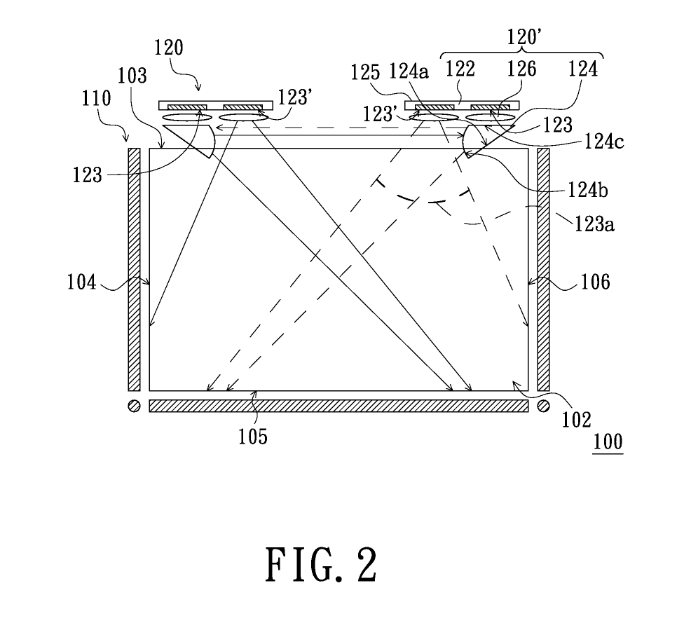

FIG. 2 is a schematic view of an optical touch device in accordance with an embodiment of the present invention. Referring to FIG. 2, in the present embodiment, an optical touch device 100 has a touch area 102. The optical touch device 100 includes at least a light sensing module. In the present embodiment, as shown in FIG. 2, the optical touch device 100 includes, for example, two light sensing modules 120, 120′. The first sensing module 120 is a first light sensing module, and the second sensing module 120′ is a second light sensing module. Each of the two light sensing modules 120, 120′ includes a sensing unit 122 and at least a reflecting member 124. For example, only one reflecting member 124 is shown in FIG. 2. The sensing unit 122 has a plurality of sensing regions. In the present embodiment, as shown in FIG. 2, the sensing unit 122 includes, for example, two sensing regions 123, 123′. The sensing region 123 is a first sensing region, and the sensing region 123′ is a second sensing region. Each of the two sensing regions 123, 123′ has a field of view 123a. The fields of view 123a of the two adjacent sensing regions 123, 123′ of the sensing unit 122 are, for example, partially overlapped. Additionally, the reflecting member 124 is disposed in the front of at least one of the sensing regions 123, 123′. In the present embodiment, the reflecting member 124 is disposed in the front of the sensing region 123 so as to turn the field of view 123a of the corresponding sensing region 123.

In detail, the touch area 102 is, for example, rectangular, and has a first side 103, a second side 104, a third side 105 and a fourth side 106. The first side 103 faces to the third side 105, and the second side 104 faces to the fourth side 106. The light sensing modules 120, 120′ are disposed beside the first side 103. The light sensing module 120 is near to the second side 104, and the light sensing module 120′ is near to the fourth side 106. In addition, the sensing regions 123, 123′ of the sensing unit 122 of each of the light sensing modules 120, 120′ face to the touch area 102. In the light sensing module 120, the sensing region 123 is nearer to the second side 104 than the sensing region 123′. The reflecting member 124 in the front of the sensing region 123 of the light sensing module 120 is configured for turning the field of view 123a of the sensing region 123 of the light sensing module 120 towards the fourth side 106. In the light sensing module 120′, the sensing region 123 is nearer to the fourth side 106 than the sensing region 123′. The reflecting member 124 in the front of the sensing region 123 of the light sensing module 120′ is configured for turning the field of view 123a of the sensing region 123 of the light sensing module 120′ towards the second side 104. Additionally, the sensing regions 123, 123′ of the light sensing modules 120, 120′ totally cover the touch area 102.

The sensing unit 122 is, for example, a sensing chip. The sensing unit 122 includes a substrate 125. The sensing regions 123, 123′ are disposed on the substrate 125. In the present embodiment, each of the sensing regions 123, 123′ of the sensing unit 122 is an individual sensing region of the sensing chip. In another embodiment, the sensing unit 122 is, for example, a sensing chip. The sensing regions 123, 123′ of the sensing unit 122 are sub-regions divided from a sensing region of the sensing chip. In still another embodiment, the sensing unit 122 can further includes a plurality of sensing chips. Each of the sensing chips includes one of the sensing regions 123, 123′. Additionally, the sensing unit 122 and the reelecting member 124 can be two separated components, or be received in a package together.

In the present embodiment, the reflecting member 124 is, for example, a prism. The prism includes a reflecting surface 124a, a light incidence surface 124b and a light emitting surface 124c. The light emitting surface 124c faces to the sensing region 123, and is connected between the reflecting surface 124a and the light incidence surface 124b. The light incidence surface 124b can be a convex curved surface so as to enlarge the field of view 123a of the sensing region 123. In addition, each of the light sensing modules 120, 120′ can further include a plurality of lenses 126. The lenses 126 are respectively disposed in the front of the sensing regions 123, 123′ so as to enlarge the fields of view 123a of the sensing regions 123, 123′. The number of the lenses 126 in the front of the sensing regions 123, 123′ is not limited by the embodiment of the present invention. Additionally, in the present embodiment, the optical touch device 100 further includes, for example, at least an infrared light source module 110 for providing optical signals to the touch area 102. In FIG. 2, three infrared light source modules 110 are taken as an example, and the three infrared light source modules 110 are respectively disposed beside the second side 104, the third side 105 and the fourth side 106 of the touch area 102.

In the optical touch device 100 of the present embodiment, the reflecting member 124 disposed in the front of the sensing region 123 is configured for turning the field of view 123a of the sensing region 123. Thus, the location and the angle of disposing the sensing unit 122 are not limited. In other words, in the present embodiment, the location and the angle of disposing the sensing unit 122 of the optical touch device 100 are flexible. Thus, a receiving space of an electronic product is not limited during designing the electronic product. Therefore, the optical touch device 100 in the present embodiment is easily applied to the electronic products having a limited inner space and further benefits reducing the volume of the electronic product.

It should be noted that the location and the angle of disposing the light sensing module 120/120′ in the present embodiment are examples, which can be adjusted according to the demand. An included angle between the reflecting surface 124a and the light emitting surface 124c of the reflecting member 124 can also be adjusted according to the demand. Thus, the location and the angle of disposing the light sensing modules 120/120′ can further be flexible. In addition, although the exemplary two light sensing modules 120, 120′ are described in the present embodiment, the optical touch device in another embodiment can include either one the light sensing module or more than two light sensing modules. Additionally, the infrared light source modules 110 can be disposed around the touch area 102.

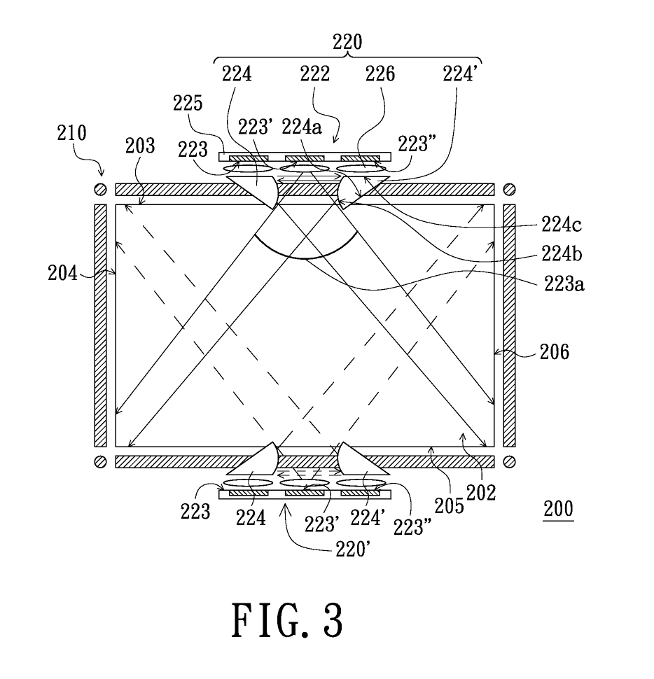

FIG. 3 is a schematic view of an optical touch device in accordance with another embodiment of the present invention. Referring to FIG. 3, an optical touch device 200 in the present embodiment is similar to the aforesaid optical touch device 100. The differences of the optical touch device 200 and the optical touch device 100 are described as follows. The optical touch device 200 includes two light sensing modules 220, 220′. The light sensing module 220 is a first light sensing module, and the light sensing module 220′ is a second light sensing module. The light sensing module 220 is disposed beside a first side 203 of a touch area 202, and the light sensing module 220′ is disposed beside a third side 205 of the touch area 202. The light sensing module 220 faces to the light sensing module 220′. Each of the light sensing modules 220, 220′ includes a sensing unit 222 and two reflecting members 224, 224′. The reflecting member 224 is a first reflecting member, and the reflecting member 224′ is a second reflecting member. In addition, the sensing unit 222 includes three sensing regions 223, 223′, 223″ facing to the touch area 202. The sensing region 223 is a first sensing region, the sensing region 223′ is a second sensing region, and the sensing region 223″ is a third sensing region. The sensing region 223′ is located between the sensing region 223 and the sensing region 223″. The sensing region 223 is nearer to a second side 204 of the touch area 202 than the sensing region 223′.

Each of the sensing regions 223, 223′, 223″ has a field of view 223a. The reflecting member 224 disposed in the front of the sensing region 223 is configured for turning the field of view 223a of the sensing region 223 towards the fourth side 206. The reflecting member 224′ disposed in the front of the sensing region 223″ is configured for turning the field of view 223a of the sensing region 223″ towards the second side 204. In addition, the fields of view 223a of the two adjacent sensing regions 223, 223′ are, for example, partially overlapped, and the fields of view 223a of the two adjacent sensing regions 223′, 223″ are also, for example, partially overlapped.

The sensing unit 222 is, for example, a sensing chip. The sensing unit 222 includes a substrate 225. The sensing regions 223, 223′, 223″ of the sensing unit 222 are disposed on the substrate 225. In the present embodiment, each of the sensing regions 223, 223′, 223″ of the sensing unit 222 is an individual sensing region of the sensing chip. In another embodiment, the sensing unit 222 is, for example, a sensing chip. The sensing regions 223, 223′, 223″ of the sensing unit 222 are sub-regions divided from a sensing region of the sensing chip. In still another embodiment, the sensing unit 222 can further includes a plurality of sensing chips. Each of the sensing chips includes one of the sensing regions 223, 223′, 223″. Additionally, the sensing unit 222 and the reflecting members 224′, 224″ can be three separated components, or be received in a package together.

In the present embodiment, each of the reflecting members 224, 224′ is, for example, a prism. The prism includes a reflecting surface 224a, a light incidence surface 224b and a light emitting surface 224c. The light incidence surface 224b is connected between the reflecting surface 224a and the light emitting surface 224c. The light emitting surface 224c of the reflecting member 224 faces to the touch area 223, and the light emitting surface 224c of the reflecting member 224′ faces to the touch area 223″. The light incidence surface 224b can be a convex curved surface so as to enlarge the field of view 223a of the sensing region 223/223″. In addition, each of the light sensing modules 220, 220′ can further include a plurality of lenses 226. The lenses 226 are respectively disposed in the front of the sensing regions 223, 223′, 223″ so as to enlarge the fields of view 223a of the sensing regions 223, 223′, 223″. The number of the lenses 226 in the front of the sensing regions 223, 223′, 223″ is not limited by the embodiment of the present invention. Additionally, in the present embodiment, the optical touch device 200 further includes, for example, at least an infrared light source module 210 for providing optical signals to the touch area 202. In FIG. 3, four infrared light source modules 210 are taken as an example, and the four infrared light source modules 210 are respectively disposed beside the first side 203, the second side 204, the third side 205 and the fourth side 206 of the touch area 202.

The advantages of the optical touch device 200 are similar to the advantages of the optical touch device 100 and are not described here. Additionally, in the present embodiment, the location and the angle of disposing the light sensing module 222 can be adjusted according to the demand. The optical touch device 200 can include either one the light sensing module or more than two light sensing modules.

In summary, the optical touch device and the light sensing module of the present invention has at least the following advantages:

1. The light sensing module includes the sensing regions and the reflecting member is disposed in the front of at least one of the sensing regions so as to turn the field of view of the corresponding sensing region. Thus, the location and the angle of disposing the light sensing module are flexible.

2. Because the location and the angle of disposing the light sensing module of the optical touch device are flexible, the optical touch device is easily applied to the electronic product having a limited inner space and further benefits reducing the volume of the electronic product.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch device having a touch area, comprising:
at least a light sensing module disposed beside the touch area, and the light sensing module comprising:
a sensing unit having a plurality of sensing regions, and each of the sensing regions having a field of view; and
at least a reflecting member disposed in the front of at least one of the sensing regions to turn the field of view of the corresponding sensing region.

2. The optical touch device as claimed in claim 1, wherein the touch area is rectangular and has a first side, a second side, a third side and a fourth side, the first side faces to the third side, and the second side faces to the fourth side.

3. The optical touch device as claimed in claim 2, wherein the at least a light sensing module comprises a first light sensing module disposed beside the first side and a second light sensing module disposed beside the first side, the first light sensing module is near to the second side, the second light sensing module is near to the fourth side, the sensing unit of each of the first light sensing module and the second light sensing module comprising a first sensing region facing to the touch area and a second sensing region facing to the touch area, the reflecting member of the first light sensing module is disposed in the front of the first sensing region of the first light sensing module and is configured for turning the field of view of the first sensing region of the first light sensing module towards the fourth side, the reflecting member of the second light sensing module is disposed in the front of the first sensing region of the second light sensing module and is configured for turning the field of view of the first sensing region of the second light sensing module towards the second side.

4. The optical touch device as claimed in claim 3, wherein the first sensing region of the first light sensing module is nearer to the second side than the second sensing region of the first light sensing module, and the first sensing region of the second light sensing module is nearer to the fourth side than the second sensing region of the second light sensing module.

5. The optical touch device as claimed in claim 2, wherein the at least a light sensing module comprises a first light sensing module disposed beside the first side and a second light sensing module disposed beside the third side, the first light sensing module faces to the second light sensing module, the sensing unit of each of the first light sensing module and the second light sensing module comprising a first sensing region facing to the touch area, a second sensing region facing to the touch area and a third sensing region facing to the touch area, each of the first light sensing module and the second light sensing module comprises two the reflecting members, one of the reflecting members is disposed in the front of the first sensing region and is configured for turning the field of view of the first sensing region towards the fourth side, and the other of the reflecting members is disposed in the front of the third sensing region and is configured for turning the field of view of the third sensing region towards the second side.

6. The optical touch device as claimed in claim 5, wherein the second sensing region is located between the first sensing region and the third sensing region, and the first sensing region is nearer to the second side than the second sensing region.

7. The optical touch device as claimed in claim 1, wherein each light sensing module further comprises a plurality of lenses disposed in the front of the sensing regions respectively.

8. The optical touch device as claimed in claim 1, wherein each reflecting member is a prism, the prism has a light incidence surface, a reflecting surface and a light emitting surface, the light emitting surface faces to the corresponding sensing region and is connected between the reflecting surface and the light incidence surface, and the light incidence surface is a convex curved surface.

9. The optical touch device as claimed in claim 1, wherein each sensing unit further comprises a plurality of sensing chips, and each of the sensing chips comprises one of the sensing regions of each sensing unit.

10. The optical touch device as claimed in claim 1, wherein each sensing unit further comprises a sensing chip having a substrate, the sensing regions of each sensing unit are disposed on the substrate.

11. The optical touch device as claimed in claim 1, wherein the fields of view of two adjacent sensing regions of each sensing unit are partially overlapped.

12. The optical touch device as claimed in claim 1, further comprising at least an infrared light source module.

13. A light sensing module for an optical touch device, comprising:
a sensing unit having a first sensing region and a second sensing region, and each of the first sensing region and the second sensing region having a field of view; and
a reflecting member disposed in the front of the first sensing region to turn the field of view of the first sensing region.

14. The light sensing module as claimed in claim 13, wherein the sensing unit further comprises a substrate, the first sensing region and the second sensing region are disposed on the substrate, and the sensing unit and the reflecting member are received in a package together.

15. The light sensing module as claimed in claim 13, further comprising a plurality of lenses disposed in the front of the first sensing region and second sensing region respectively.

16. The light sensing module as claimed in claim 13, wherein the reflecting member is a prism, the prism has a light incidence surface, a reflecting surface and a light emitting surface, the light emitting surface faces to the corresponding sensing region and is connected between the reflecting surface and the light incidence surface, and the light incidence surface is a convex curved surface.

17. The light sensing module as claimed in claim 13, wherein the fields of view of the first sensing region and the second sensing region are partially overlapped.

18. A light sensing module for an optical touch device, comprising:
a sensing unit having a first sensing region, a second sensing region and a third sensing region, and each of the first sensing region, the second sensing region and the third sensing region having a field of view;
a first reflecting member disposed in the front of the first sensing region to turn the field of view of the first sensing region; and
a second reflecting member disposed in the front of the third sensing region to turn the field of view of the third sensing region.

19. The light sensing module as claimed in claim 18, wherein the sensing unit further comprises a substrate, the first sensing region, the second sensing region and the third sensing region are disposed on the substrate, and the sensing unit, the first reflecting member and the second reflecting member are received in a package together.

20. The light sensing module as claimed in claim 18, further comprising a plurality of lenses disposed in the front of the first sensing region, the second sensing region and the third sensing region respectively.

21. The light sensing module as claimed in claim 18, wherein each of the first reflecting member and the second reflecting member is a prism, the prism has a light incidence surface, a reflecting surface and a light emitting surface, the light incidence surface is connected between the reflecting surface and the light emitting surface and is a convex curved surface, the light emitting surface of the first reflecting member faces to the first sensing region, and the light emitting surface of the second reflecting member faces to the third sensing region.

22. The light sensing module as claimed in claim 18, wherein the fields of view of the first sensing region and the second sensing region are partially overlapped, and the fields of view of the first sensing region and the third sensing region are partially overlapped.
